(19) United States
(12) Patent Application Publication
(10) Pub. No.: US 2016/0091362 A1
(43) Pub. Date: Mar. 31, 2016

(54) AIRCRAFT FLIGHT CHARACTERISTIC MEASUREMENT

(71) Applicants: Fredric H. Schmitz, Palo Alto, CA (US); N. Sudarshana Koushik, Silver Spring, MD (US); Richard D. Sickenberger, Bel Air, MD (US); William T. Eckert, Colorado Springs, CO (US)

(72) Inventors: Fredric H. Schmitz, Palo Alto, CA (US); N. Sudarshana Koushik, Silver Spring, MD (US); Richard D. Sickenberger, Bel Air, MD (US); William T. Eckert, Colorado Springs, CO (US)

(21) Appl. No.: 14/500,681

(22) Filed: Sep. 29, 2014

(51) Int. Cl. G01H 17/00; G01M 17/00

(52) U.S. Cl. CPC G01H 17/00; G01M 17/00

(57) ABSTRACT

A method and device of measuring external flight characteristics of aircraft, including fixed-wing, rotorcraft, and Unmanned Aerial Vehicles, utilizes one or more floating platforms, each supporting one or more measuring instruments. The floating platform may be a hot air balloon, dirigible or other quasi-neutrally-buoyant airship, untethered to avoid interference between the aircraft being measured and any tether. Measurement of rotorcraft acoustic characteristics is particularly enhanced by permitting measurements that account for directionality of noise sources and are not affected by wind or reflected noise.

### BACKGROUND OF THE INVENTION

1. Field of the Invention

The present invention relates to a method and device for measuring external flight characteristics of aircraft.

2. Description of the Prior Art

As aircraft improvements are designed and implemented, it is advantageous to accurately measure various external characteristics of each model, to determine relative advantages and consider needed improvements. For example, since it is desirable to minimize sound generated by helicopters in a combat situation, it is important to be able to accurately measure actual noise resulting from each type of helicopter.

A number of aircraft characteristic measurement methods are currently used. Ground-to-vehicle microphone noise measurements of fixed- and rotary-wing aircraft are typically accomplished through arrays of microphones affixed to stationery ground-boards set on the surface of the ground. Such arrays permit a fairly simple method of measuring sound generated by aircraft flying above the microphones. However, ground measuring systems are not useful for accurately measuring sound which is experienced primarily above the aircraft, such as above-the-vehicle acoustic radiation which would be observed if a helicopter was flying in a canyon below the position in which noise was being detected. Furthermore, rotorcraft frequently maneuver in ways which cause the rotors not to be parallel with the ground, so that the noise generated from the top of the rotors is perceived from areas generally below and beyond the aircraft. Thus, it is important to have an accurate method of measuring the amplitude and frequency of sound which is emitted above the rotors, which is not easily accomplished by on-the-ground measurements.

To provide an opportunity to measure directional noise emitted above the aircraft, some measuring systems utilize stable elevated measuring instruments, such as microphones mounted on a tower. These measuring devices will likely respond to sound which travels on a direct path from the aircraft and also to sound which is reflected as sound travels from the aircraft to the ground. This reflected sound observed by the elevated measuring device is not easily suppressed or distinguished from direct sound, making it difficult to accurately measure just the actual sound generated by the aircraft.

Acoustic measurements made from a second aircraft flying in formation with the subject vehicle are advantageous because both the aircraft to which measuring devices are mounted and the aircraft for which sound measurements are desired can fly at high enough altitudes to avoid significant ground reflections. However, because the aircraft-mounted measuring devices are exposed to the wind, sound measurements may reflect the background noise generated by the wind. In addition, it is risky to fly the aircraft directly above and forward of the vehicle being measured since wake from the measuring aircraft could create unsteady aerodynamic disturbances, making formation flying difficult. This risk is particularly acute when obtaining measurements of sound emitted directly above a rotorcraft, since wake from the measuring aircraft could create unsteady aerodynamic rotor disturbances. Furthermore, the wake of the measuring aircraft may change the airflow around the rotor of the rotorcraft, affecting the true sound characteristics for which measurements are sought.

It is possible to mount measuring devices on the aircraft for which measurements are desired, such as microphones attached to a spray boom mounted beneath a helicopter. However, because the microphones are mounted directly to the aircraft, the range of radiation angles that can be captured are limited. It is particularly difficult to measure lower frequency noise generated by the main rotor of a helicopter by such methods.

A method and system are needed for accurately measuring external aircraft characteristics which permits measurement directly above the aircraft, is not altered by ground reflections, and does not make flying conditions more difficult because of the proximity of an aircraft making measurements. When the measurement system is used to measure acoustic characteristics, it is beneficial to have good acoustic signal to background noise levels and to avoid distortion of acoustic radiation patters by changes of the airflow field.

### SUMMARY AND OBJECTS OF THE INVENTION

A primary object of the present invention is to provide a method and system for accurately measuring external characteristics of aircraft, such as emitted sound, while minimizing interference from ground reflection and other aircraft.

Another object of the present invention is to provide such a measurement method and system which minimizes background noise or other interference with the collection of accurate data.

Another object of the present invention is to provide such a measurement method and system that allows the collection of noise characteristic data directly above the rotorcraft or aircraft.

Yet another object of the present invention is to provide such a measurement method and system which is safe and free from potentially dangerous effects of tethers or interference from the wake of other aircraft.

These objects are achieved by a method of measuring external characteristics of aircraft by supporting a measuring instrument on a floating platform. The floating it platform can be a hot air balloon, a dirigible, or other quasi-neutrally-buoyant aircraft, including a rigid or non-rigid, free-flying or controllable, lighter-than-air aircraft. Such aircraft float with the wind, minimizing any skewing of measurement data which might otherwise be created by the wind. Therefore, background noise due to wind is negligible. Because any burners or motors can be turned off while measurements are being taken, there is virtually no background noise or interference created by the measuring platform.

Depending on the type of floating platform and the characteristics of the measuring instrument, the measuring instrument can be mounted to or suspended from the platform by conventional methods. For example, the measuring instrument can be attached to a basket of a hot air balloon, or suspended by a line beneath the bottom of a dirigible.

The measuring method claimed herein can be used to measure different external characteristics, including acoustic, thermal, or vibration, by varying the type of measuring instrument which is supported by the floating platform. A particularly useful application of the instant method is the measurement of sound generated by rotorcraft, including noise which is generated upwards from the primary rotors, which has previously been difficult to accurately and safely determine.

When a microphone or other sound-measuring instrument is suspended by a line from a hot air balloon basket, the balloon can be positioned above a flight path of a rotorcraft. The balloon may ideally be positioned more than three hundred feet above the rotorcraft flight path, allowing measurement of far-field noise. Although the hot air burner is turned off during measurements to avoid background noise, a typical hot air balloon can maintain an altitude with not more than one hundred foot change for about 45 seconds of measuring time, by applying the burner for 10-15 seconds when measurements are not being made. Furthermore, movement of the balloon by the wind actually minimizes detection of wind noise by the microphone.

The claimed method allows measurement of a wide range of directivity angles of rotorcraft noise. Once the floating platform is positioned, different flight paths can be chosen beneath the platform, at a variety of angles relative to the ground, to enable measurements to be made of sound emitted above the rotors at different angles.

The floating platform can be piloted to allow for in-flight corrections and modifications of measuring equipment. Alternatively, the floating platform can be unpiloted but remotely controlled. Therefore, there is no need to tether the balloon to the ground, providing a safe flight path for the measured aircraft beneath the balloon or dirigible.

### BRIEF DESCRIPTION OF THE DRAWINGS

FIG. 1 is a perspective view of a method of measuring external flight characteristics of an aircraft, according to the present invention.

FIG. 2 is a perspective view of an existing method of measuring external flight characteristics of an aircraft.

FIG. 3 is a depiction of the areas in which acoustic data can be accurately measured using the method of the present invention.

FIG. 4 is a perspective view of a method of measuring external flight characteristics of an aircraft using an array of measuring devices.

In the drawings, the following legend has been used:

| | |
|---|---|
| 10 | Aircraft characteristics measurement system |
| 12 | Aircraft |
| 14 | Flight path |
| 16 | Global positioning system inertial navigation unit (GPS/INU) |
| 18 | Floating platform |
| 20 | Measuring instrument |
| 22 | Attachment line |
| 30 | Tower |
| 32 | Direct source path of measured acoustic data |
| 34 | Reflected source path of measured acoustic data |
| 36 | Area above aircraft |
| 38 | Area below aircraft |
| 40 | Acoustic blind spot |
| 42 | Recording sphere |
| 44 | Array of measuring devices |

### DESCRIPTION OF THE PREFERRED EMBODIMENT

The present invention concerns a method and device for measuring external characteristics of aircraft. In the following description, numerous specific details are set forth in order to provide a thorough understanding of the present invention. It will be obvious, however, to one skilled in the art that the present invention may be practiced without these specific details. Some well-known methods and structures have not been set forth in order not to unnecessarily obscure the description of the present invention.

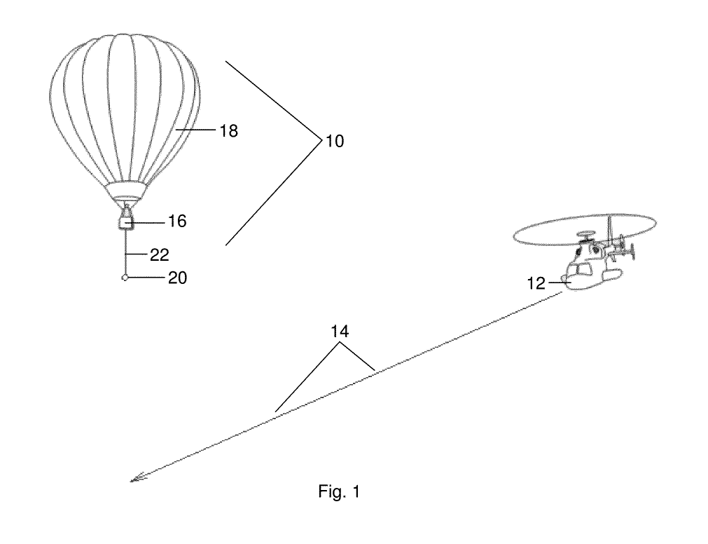

As best shown in FIG. 1, a system 10 for measuring external characteristics of aircraft 12 relies on a measuring instrument 20 supported by a floating platform 18. The particular measuring instrument 20 is chosen depending on the type of characteristics to be measured. For example, if the system 10 is to be used to measure acoustic characteristics of a particular aircraft 12, a microphone and analog to digital converter may beneficially be selected as the instrument 20.

The floating platform 18 may be a hot air balloon, a dirigible, or other quasi-neutrally-buoyant aircraft, including a rigid or non-rigid, free-flying or controllable, lighter-than-air aircraft. The measuring instrument 20 can be supported by and attached to the floating platform 18 by numerous different conventional means. For example, a thermometer 20 could be glued or tied to the exterior surface of a dirigible 18 to track heat emitted by a particular drone 12. Or, a microphone 20 could be suspended by an attachment line 22 from a hot air balloon 18, to detect sound emitted upwards from rotors of a helicopter 12 flying beneath the hot air balloon 18.

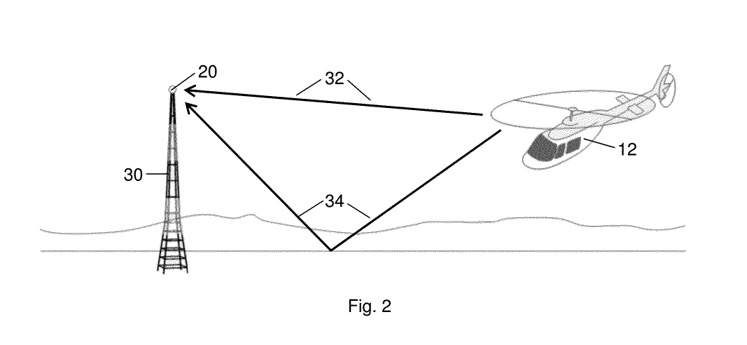

Other methods and devices for measuring external characteristics of aircraft 12 are known in the prior art. Such devices include a microphone 20 mounted on a tower 30, as shown in FIG. 2. However, a microphone 20 mounted on a stationery tower 30 will measure noise which reaches the microphone 20 over a direct source path 32 and a reflected source path 34. As a result, the data measured by a tower-mounted sound gathering device is altered and not an accurate depiction of the actual sound generated by the aircraft 12.

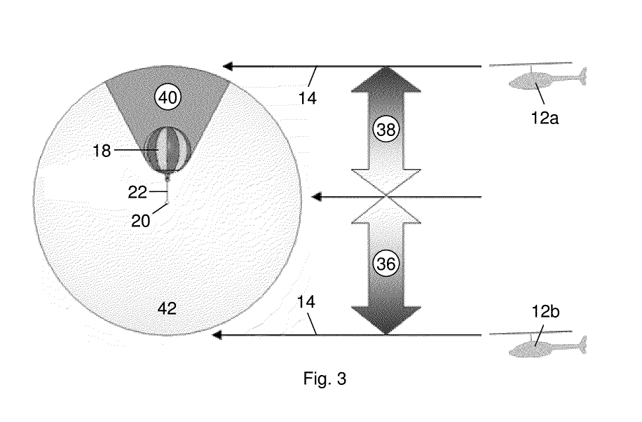

The claimed invention resolves this difficulty by providing a floating platform 18 which can be piloted or remotely controlled to a position above the expected flight path 14 of an aircraft 12. Measurements of characteristics of the aircraft 12 can easily be made from a position immediately above the aircraft 12, which may be particularly useful when measuring sound emitted from rotors of a rotorcraft. As shown in FIG. 3, different instruments 20 may be supported by the floating it platform 18 to enable measurements to be made above an aircraft 12b flying in the area 36 below the instrument 20 or below an aircraft 12a flying in the area 38 above the instrument 20.

It is possible to use the same system 10 to observe noise generated by the aircraft 12 in multiple directions, as best shown in FIG. 3. In fact, accurate data can be obtained from an aircraft 12 at any position within the recording sphere 42 without interference. It is even possible to measure some types of data when the aircraft is in the blind spot 40, but such data may be compromised by the hot air balloon 18 between the aircraft 12 in the blind spot 40 and the measuring instrument 20, depending on the type of instrument 20. The flight path 14 may be modified from one test to another, allowing measurements to be made as the aircraft 12 is in planes with a variety of angles with respect to the earth.

Data obtained from the measuring system 10 can be most accurately interpreted to establish characteristics of an aircraft 12 when the relative position of the measuring instrument 20 to the aircraft 12 is known. By incorporating a global positioning inertial navigation unit 16 in the floating platform 18 or the measuring instrument 20, relative positions can be accurately determined and recorded.

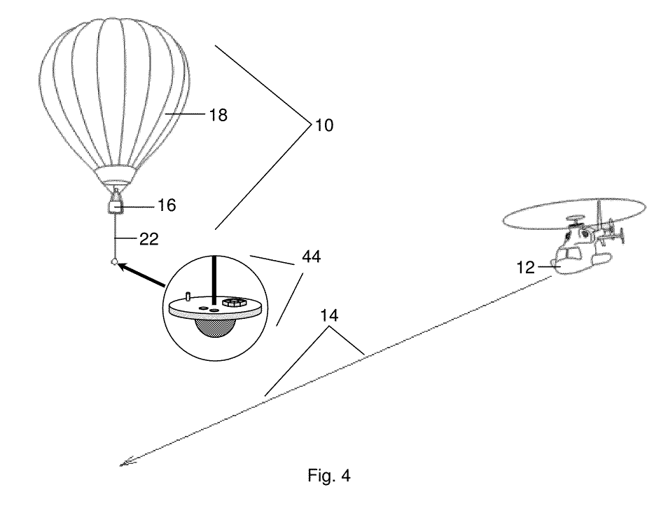

It is also possible to configure the floating platform 18 with multiple measurement devices 20 such that a measurement array 44 is formed. In a preferred embodiment, the measurement devices 20 would be mounted in a rigid structure in fixed chosen array patterns and suspended from the floating platform 18, as shown in FIG. 4. This array 44 of sensors 20 could effectively increase the signal to noise levels of the measured data. The array 44 can also provide a directional sensor capability when it is designed to amplify signals in certain preferred directions through beam-forming technologies known in the prior art. When such a system is deployed, the position of each sensor 20 is beneficially recorded in space along with measurements of the vehicle 12 to maximize the accuracy of data recorded by the moving array 44 of sensors 20. Wide separation distances between individual measuring devices 20, such as microphones, can advantageously provide good low frequency resolution of the measured signals.

Alternatively, the array 44 could be formed by supporting multiple separate measuring devices 20 on separate floating platforms 18. In this embodiment, the relative and absolute positions of each measurement device 20 should be measured and recorded along with the measured data of interest. Using multiple floating platforms 18 would allow relatively large separation distances between the measurement devices 20 and the subject aircraft 12 to enhance low-frequency measurement and beam-forming signals.

Although the present invention has been described in terms of the presently preferred embodiment, it is to be understood that such disclosure is purely illustrative and is not to be interpreted as limiting. Consequently, without departing from the spirit and scope of the invention, various alterations, modifications, or alternative applications of the invention will, no doubt, be suggested by those skilled in the art after having read the preceding disclosure. Accordingly, it is intended that the following claims be interpreted as encompassing all alterations, modifications, or alternative applications as fall within the true spirit and scope of the invention.

We claim:

1. A method for measuring aircraft external flight characteristics, comprising the steps of:
a. supporting a measuring instrument by a platform floating in air,
b. flying an aircraft in proximity to said instrument, and
c. using said instrument to measure flight characteristics of said aircraft.

2. A method according to claim 1, wherein said measuring instrument comprises a sound measuring device for measuring sound waves.

3. A method according to claim 1, wherein said platform comprises an untethered hot air balloon.

4. A method according to claim 1, wherein said platform comprises an untethered dirigible.

5. A method according to claim 1, further comprising:
d. determining relative positions of said platform and said aircraft and
e. analyzing effect of said relative positions on measured flight characteristics.

6. A method according to claim 5, wherein relative positions of said platform and said aircraft are determined by using digital global positioning system.

7. A method according to claim 1, further comprising a plurality of measuring instruments supported by said platform.

8. A method according to claim 1, further comprising a plurality of floating platforms, each supporting at least one measuring instrument.

9. A method according to claim 1, in which measurement of flight characteristics is not affected by wind.

10. A device for measuring aircraft external flight characteristics of an aircraft, comprising:
a. measuring instrument for measuring flight characteristics of ah aircraft,
b. platform floating in air, and
c. support means for supporting said measuring instrument by said platform.

11. A device for measuring aircraft external flight characteristics according to claim 10, wherein said measuring instrument comprises a sound measuring device for measuring sound waves.

12. A device for measuring aircraft external flight characteristics according to claim 10, wherein said platform comprises an untethered hot air balloon.

13. A device for measuring aircraft external flight characteristics according to claim 10, wherein said platform comprises an untethered dirigible.

14. A device for measuring aircraft external flight characteristics according to claim 10, further comprising:
d. means for determining relative positions of said platform and said aircraft and
e. means for analyzing effect of said relative positions on measured flight characteristics.

15. A device for measuring aircraft external flight characteristics according to claim 10, further comprising global positioning system inertial navigation unit supported by said platform.

16. A device for measuring aircraft external flight characteristics according to claim 10, further comprising a plurality of measuring instruments supported by said platform.

17. A device for measuring aircraft external flight characteristics according to claim 10, further comprising a plurality of floating platforms, each supporting at least one measuring instrument.

18. A device for measuring aircraft external flight characteristics according to claim 10, in which measurement of flight characteristics is not affected by wind.
